(19) United States
(12) Patent Application Publication
(10) Pub. No.: US 2011/0078768 A1
(43) Pub. Date: Mar. 31, 2011

(54) METHOD FOR DATA TRANSMISSION BETWEEN SERVER AND CLIENT

(75) Inventors: CHIA-HUNG CHIEN, Tu-Cheng (TW); CHUN-WEN WANG, Tu-Cheng (TW); LIANG-MAO HUNG, Tu-Cheng (TW); KAI-HO HSIUNG, Tu-Cheng (TW)

(73) Assignee: HON HAI PRECISION INDUSTRY CO., LTD., Tu-Cheng (TW)

(21) Appl. No.: 12/622,610

(22) Filed: Nov. 20, 2009

(30) Foreign Application Priority Data
Sep. 30, 2009 (CN) 200910308044.X

(51) Int. Cl. G06F 21/00; G06F 15/16

(52) U.S. Cl. 726/4; 709/227; 709/203

(57) ABSTRACT

A method is used for data transmission between a server and a client. The method includes the following steps. The server receives a request from the client through a network. The server determines if the client has access authorization. The server creates a background process when acquiring the access authorization. The server receives a data block and a status checking request from the client. The background process sends a data report to the client for each data block received. The server submits a status report in response to the status checking request.

### BACKGROUND

1. Technical Field

The disclosure generally relates to methods for data transmission from clients to servers via a network.

2. Description of Related Art

Currently, a large number of computers or servers provided by some web sites or individuals are connected to the Internet. However, parts of these computers or servers may be seldom used or perform the occasional minor task. These computers or servers may be idle at times.

### BRIEF DESCRIPTION OF THE DRAWINGS

FIG. 1 is a block view showing an embodiment of server system.

FIG. 2 is a block flowchart of an embodiment of a method for receiving data from a client by a server.

FIG. 3 is a continuation of the block flowchart of FIG. 2.

### DETAILED DESCRIPTION

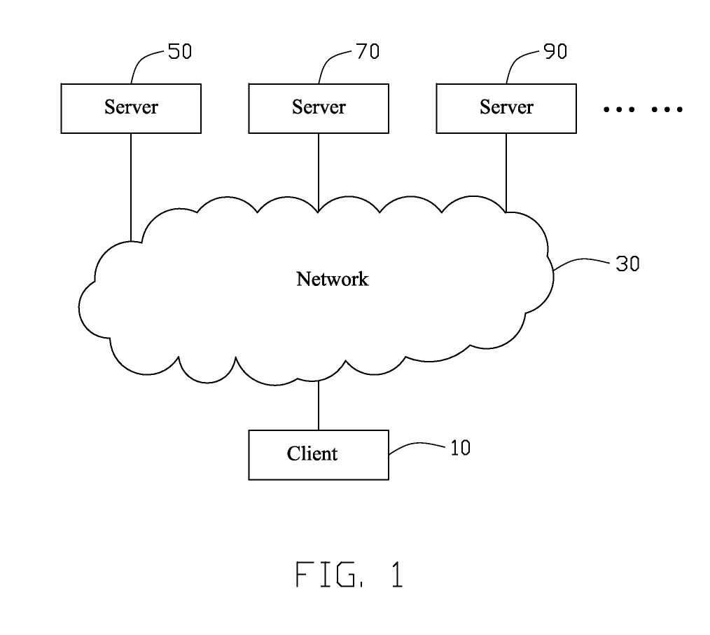

Referring to FIG. 1, a server system includes a network 30, a client 10 and a plurality of servers 50, 70 and 90 are connected to the network 30. The network 30 can be the Internet and/or an intranet. The client 10 can transmit data to the servers. The client 10 may be an embedded electronic device.

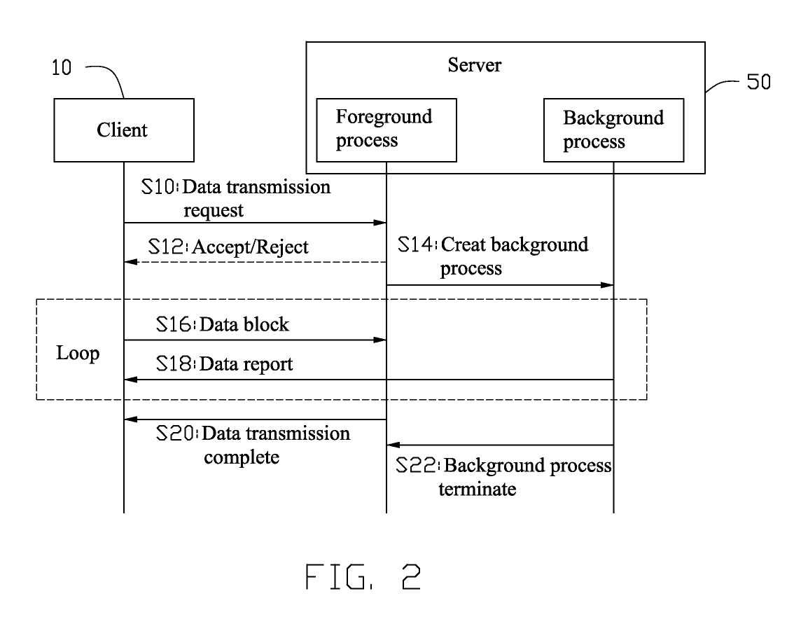

Referring to FIG. 2, a method for data transmission between a server and a client includes the following steps.

In step S10, the server 50 is active and a foreground process is running. The foreground process receives a data transmission request from the client 10 through the network 30.

In step S12, the foreground process analyzes a login information from the client 10 to determine if the client 10 has access authorization and replies to the client 10. If the client 10 has authorization, step S14 is implemented. If no authorization, the server 50 rejects the request from the client 10. The server 50 may log an IP address and a name of the client to construct a connection to the client 10 after determining the client 10 has authorization.

In step S14, the server 50 creates a background process.

In step S16, the foreground process receives a data block from the client 10.

In step S18, the background process sends a data report to the client 10 for each data block received by the background process. The client 10 may determine if the received data block is identical to the sent data block. The client 10 may resend the sent data block to the server 50 if the data block received by the server 50 differs from the sent data block. The client 10 may stop sending data blocks to the server 50 after a predetermined period if no data report is received from the server 50. When a plurality of data blocks is transmitted from the client 10 to the server 50, loop through step S16 to step S18 occurs.

In step S20, when the foreground process receives an end data block from the client 10, the data block transmission is finished, the foreground process sends complete inform to the clients 10.

In step S22, the background process is terminated.

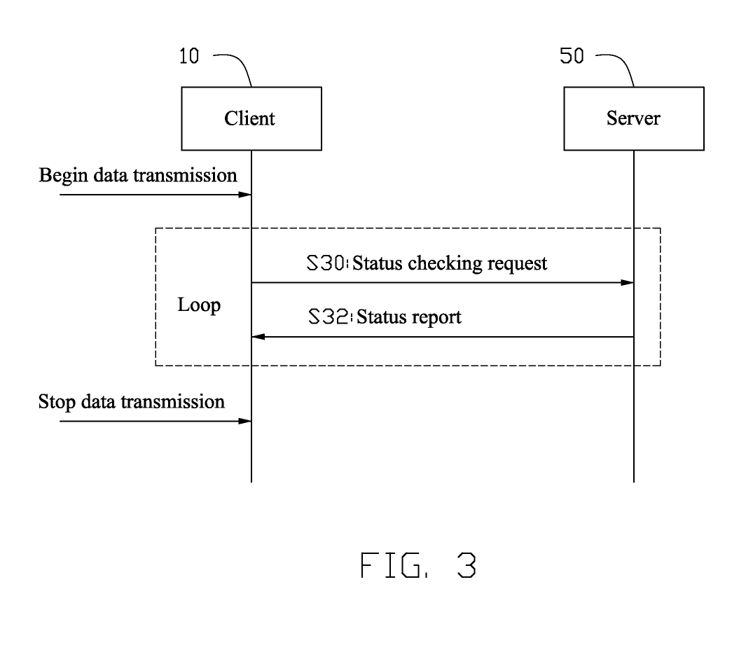

Referring to FIG. 3, the method may further include the following steps.

In step S30, the server 50 receives a status checking request from the client 10.

In step S32, the background process of the server 50 submits a status report to the client 10 in response to the status checking request. The status report indicates one of a normal status and a busy status of the server 50. The client 10 stops sending data blocks to the server 50 when the status report indicates busy status. The data block and the status checking request may be sent to the server 50 simultaneously by the client 10.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for data transmission between a server and a client, the method comprising:
receiving a request from the client through a network;
determining if the client has access authorization;
creating a background process when acquiring the access authorization;
receiving data blocks and a status checking request from the client;
sending a data report to the client from the background process for each data block received by the background process; and
submitting a status report in response to the status checking request.

2. The method of claim 1 further comprising: the client determining if the received data block is identical to the sent data block.

3. The method of claim 2 further comprising: the client resending the sent data block to the server if the data block received by the server differs from the sent data block.

4. The method of claim 1, wherein the data block and the status checking request are sent simultaneously by the client.

5. The method of claim 1, wherein the status report indicates one of a normal status and a busy status of the server.

6. The method of claim 5, wherein the client stops sending data blocks to the server when the status report indicates busy status.

7. The method of claim 1, wherein the client stops sending data blocks to the server after a predetermined period if no data report is received from the server.

8. The method of claim 1, wherein determining if the client has the access authorization further comprises analyzing a login information from the client.

9. The method of claim 1 further comprising logging an IP address and a name of the client to construct a connection to the client after determining the client has the access authorization.

10. The method of claim 1, wherein the client is an embedded electronic device.

11. The method of claim 1, wherein the network is one of the Internet and an intranet.
